(19) United States
(12) Patent Application Publication
(10) Pub. No.: US 2021/0404218 A1
(43) Pub. Date: Dec. 30, 2021

(54) SASH LOCK ASSEMBLY FOR FENESTRATION SYSTEMS

(71) Applicant: JELD-WEN, Inc., Charlotte, NC (US)

(72) Inventor: Shane Michael Meyer, Klamath Falls, OR (US)

(21) Appl. No.: 16/915,840

(22) Filed: Jun. 29, 2020

(51) Int. Cl. E05B 65/08; E05C 3/06

(52) U.S. Cl. CPC E05B 65/0841; E05Y 2900/148; E05C 3/06

(57) ABSTRACT

The disclosure relates to a lock assembly for fenestration systems, such as sash window assemblies. The lock assembly includes an actuator with a shaft extending through a cavity of a body, where the shaft is coupled to a locking cam for rotation therewith. In this arrangement, rotation of the actuator urges rotation of the shaft within the cavity and corresponding rotation of the locking cam, where the shaft and locking cam are designed to facilitate rotation of the shaft through a greater degree of rotational positions relative to the locking cam.

### TECHNICAL FIELD

The field of the present disclosure relates generally to locking hardware for fenestration systems, and more particularly, to a sash lock assembly for double-hung windows.

### BACKGROUND

Sash window assemblies are well-known in the field. In a conventional configuration, a double-hung sash window includes a pair of sashes slidably supported along parallel planes within a frame. The sashes are mounted for slidable movement along adjacent parallel guide rails within the frame, although in some designs the upper sash may be fixed in position while only the lower sash is movable along a guide rail. Typically, to restrain movement of the sashes and lock the window, the sashes includes a sash lock assembly generally consisting of a locking cam on one of the sashes and a keeper on the other sash. In some arrangements, the locking cam is mounted on an upper rail of the lower sash window and the keeper is mounted on a lower rail of the upper sash window. To lock the double-hung sash window, an actuator coupled to the locking cam on the lower sash is rotated to drive the lock cam until it engages with the keeper on the upper sash.

In many conventional designs, the upper and lower rails of the sash windows are designed with specific width dimensions to accommodate the locking cam and keeper. However, some modern double-hung windows are designed with narrower rail widths for a more streamlined and aesthetic appeal. In such designs, it may be difficult to accommodate a conventional locking assembly with a surface mounted keeper, thereby requiring the use of other locking mechanisms that lack the aesthetic appeal of conventional sash lock assemblies. Accordingly, the present inventor has identified a need for an improved sash lock assembly for double-hung windows. Additional aspects and advantages will be apparent from the following detailed description of preferred embodiments, which proceeds with reference to the accompanying drawings.

### BRIEF DESCRIPTION OF THE DRAWINGS

FIG. 1 illustrates a double-hung sash window with a sash lock assembly in accordance with one embodiment.

FIG. 2 is an enlarged view of a bottom sash of the double-hung window of FIG. 1 illustrating the sash lock assembly on an upper rail of the bottom sash in accordance with one embodiment.

FIG. 3 is a perspective view of the sash lock assembly in accordance with one embodiment.

FIG. 4 is an exploded view of the sash lock assembly of FIG. 3 illustrating features of an actuator mechanism and a locking cam in accordance with one embodiment.

FIGS. 5-6 collectively illustrate features of the actuator mechanism of the sash lock assembly of FIG. 3 in accordance with one embodiment.

FIGS. 7-8 are rear perspective views of the sash lock assembly in an unlocked and locked configuration, respectively, in accordance with one embodiment.

FIGS. 9-10 are bottom views of the sash lock assembly in an unlocked and locked configuration, respectively, the figures collectively illustrating the movement action of the locking cam relative to an opposing rail-mounted keeper, in accordance with one embodiment.

### DETAILED DESCRIPTION OF EXAMPLE EMBODIMENTS

With reference to the drawings, this section describes embodiments of a sash lock assembly for double-hung sash windows or other suitable fenestration systems. Throughout the specification, reference to “one embodiment,” “an embodiment,” or “some embodiments” means that a described feature, structure, or characteristic may be included in at least one embodiment of the systems and methods described herein. Thus, appearances of the phrases “in one embodiment,” “in an embodiment,” or “in some embodiments” in various places throughout this specification are not necessarily all referring to the same embodiment. Furthermore, the described features, structures, and characteristics may be combined in any suitable manner in one or more embodiments. In view of the disclosure herein, those skilled in the art will recognize that the various embodiments can be practiced without one or more of the specific details or with other methods, components, materials, or the like. In some instances, well-known structures, materials, or operations are not shown or not described in detail to avoid obscuring aspects of the embodiments.

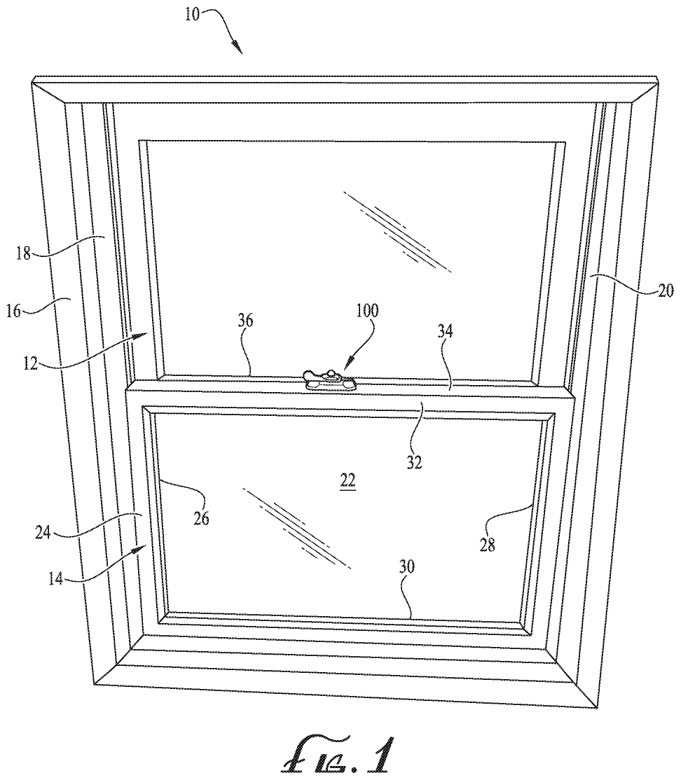

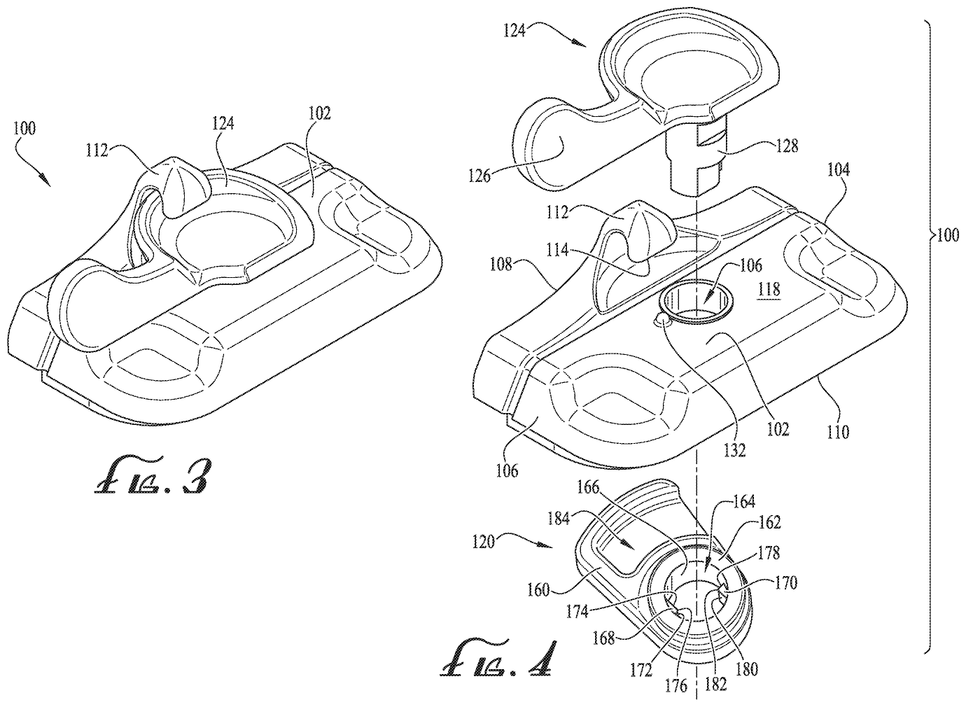

FIGS. 1-10 collectively illustrate embodiments of a sash lock assembly 100 for use with a double-hung window 10 or other suitable fenestration systems. With general reference to FIGS. 3-4, the sash lock assembly 100 includes a base or body 102 having an integrated keeper 112. The body 102 includes a cavity or bore 106 opening onto an exterior top surface 118 of the body 102, the cavity 106 designed for receiving a shaft 128 of an actuator 124. The shaft 128 extends through the cavity 106 and is coupled to a locking cam 120 positioned on an underside of the body 102. The shaft 128 drives the locking cam 120 via rotation of the handle 126 of the actuator 124 to move the sash lock assembly 100 between locked and unlocked positions as further discussed in detail below. The shaft 128 and locking cam 120 are designed to allow the handle 126 to rotate between 0° and 180°, while the locking cam 120 is constrained to a continuous or synchronized rotation therewith of between 0° and 90° when the sash lock assembly 100 moves from the unlocked position to the locked position.

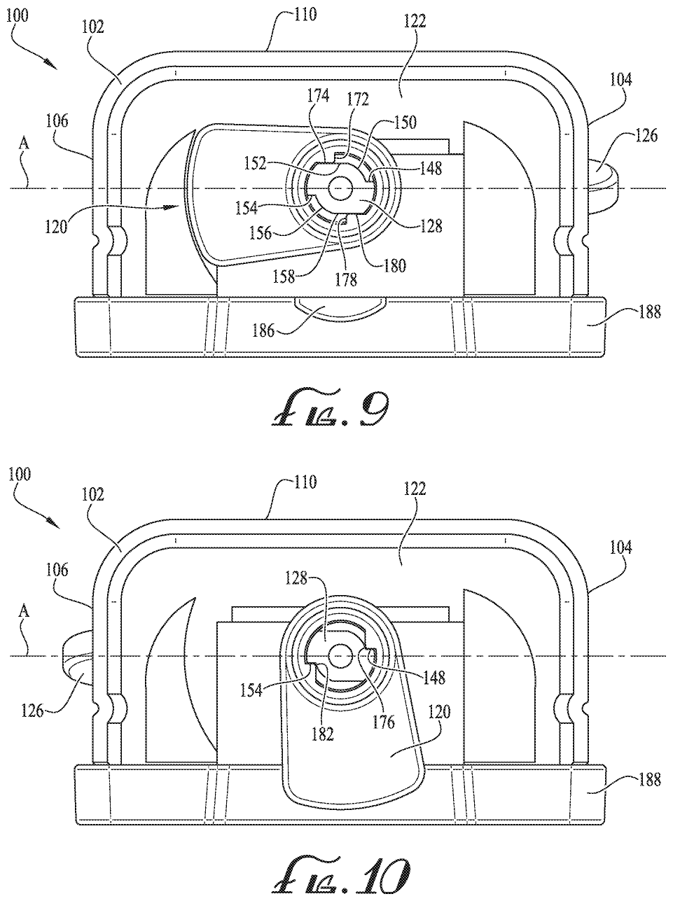

As further described in detail below, the locking cam 120 engages a catch 186 of a keeper 188 (see FIG. 9) mounted on a top sash 12 to provide a locking point for the sash lock assembly 100. The integrated keeper 112 on the sash lock assembly 100 provides an aesthetic style resembling that of a conventional sash lock assembly, but neither the actuator handle 126 nor the locking cam 120 contacts the integrated keeper 112, and the integrated keeper 112 does not otherwise serve as a locking feature or component. Rather, the locking functionality of the sash lock assembly 100 is handled by the locking cam 120 and the catch 186 of the keeper 188 mounted on the top sash 12. As designed, the sash lock assembly 100 may be used with double-hung windows 10 where the sashes are designed with narrower rail widths as compared to more conventional sash designs having substantially wider rails. Additional details of these components and embodiments of the sash lock assembly 100 are provided below with reference to the figures.

FIG. 1 illustrates a vertical lift double-hung sash window 10 including a top sash 12 and a bottom sash 14 slidably mounted in a window frame 16. The frame 16 includes opposing left and right jambs 18, 20 along which one or both sashes 12, 14 slides vertically to open and close the window 10 as desired. In some embodiments, the top sash 12 may be fixed in position and the bottom sash 14 may move upwardly and downwardly within the frame 16. Bottom sash 14 includes glazing 22 (a pane of glass or an insulated double-pane glazing unit) supported in a sash frame 24 between vertically elongate left and right stiles 26, 28. The bottom sash 14 further includes a bottom rail 30 and top rail 32 extending horizontally between the stiles 26, 28 on opposite sides of glazing 22. The top sash 12 includes the same glazing and sash frame configuration, but further details of the top sash 12 are not further discussed to avoid repetition.

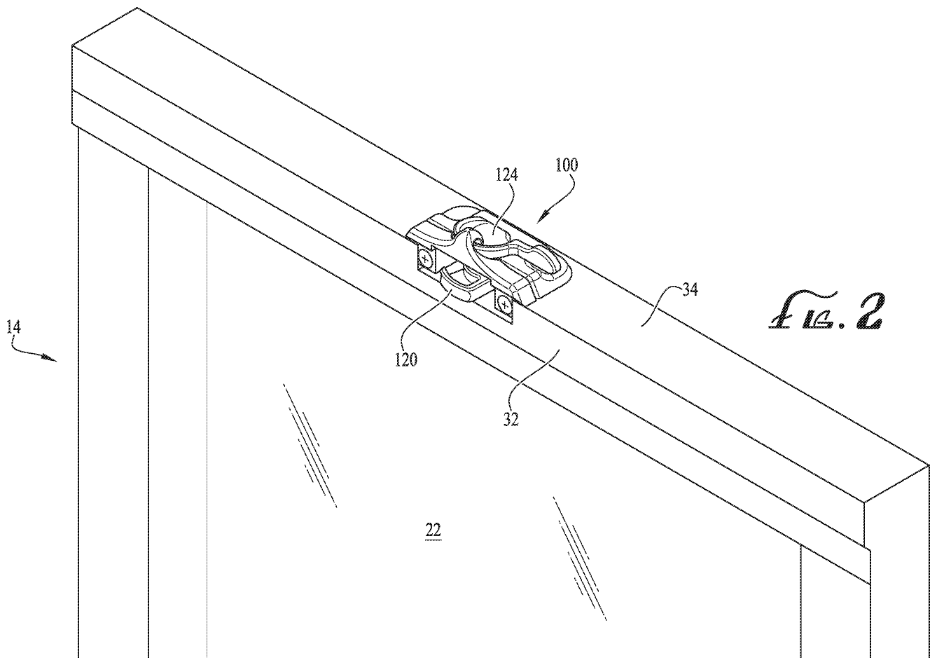

The bottom sash 14 includes a sash lock assembly 100 mounted along a top surface 34 of the top rail 32. As further discussed in detail below, the actuator 124 of the sash lock assembly 100 is manually actuatable to drive a locking cam 120 to engage the catch 186 of the keeper 188 mounted to the lower rail 36 of top sash 12 for locking the double-hung window 10 (see FIG. 9). With general reference to FIGS. 2-10, the following discussion focuses on specific details of the sash lock assembly 100 and its functionality for locking and unlocking a double-hung window 10.

FIG. 2 is a view of the bottom sash 14 and illustrates an enlarged view of the sash lock assembly 100 mounted on the top surface 34 of the top rail 32 in accordance with one embodiment. FIG. 3 is a perspective view of the sash lock assembly 100 and FIG. 4 is an exploded view of the sash lock assembly 100. With collective reference to FIGS. 2-4, the following discussion provides additional details of the components and features of the sash lock assembly 100.

With reference the figures, the sash lock assembly 100 includes a base or body 102 having peripheral sides 104, 106 and top and bottom edges 108, 110. The body 102 includes an integrated keeper 112 positioned adjacent the top edge 108, the keeper 112 including a catch 114. As noted previously, in a conventional design, the keeper and nose operate as a lock point for receiving a lever arm or handle (not shown) to lock the window. However, in the illustrated embodiments herein, the keeper 112 and the catch 114 are aesthetic features that serve no locking functionality for the sash lock assembly 100, as the catch 114 does not engage or contact the actuator 124, lever arm or handle 126, or other component of the sash lock assembly 100 in a locking fashion. Rather, the locking mechanism of the sash lock assembly 100 is handled by a locking cam 120 as described in detail below with reference to FIGS. 5-10. Returning to FIG. 3, the body 102 further includes a cavity 116 opening onto a top surface 118, the cavity 116 also being open on an opposite bottom surface 122 (see FIG. 9) of the body 102, where the openings of the cavity 116 are aligned with one another such that the cavity 116 forms an open passageway extending through the body 102.

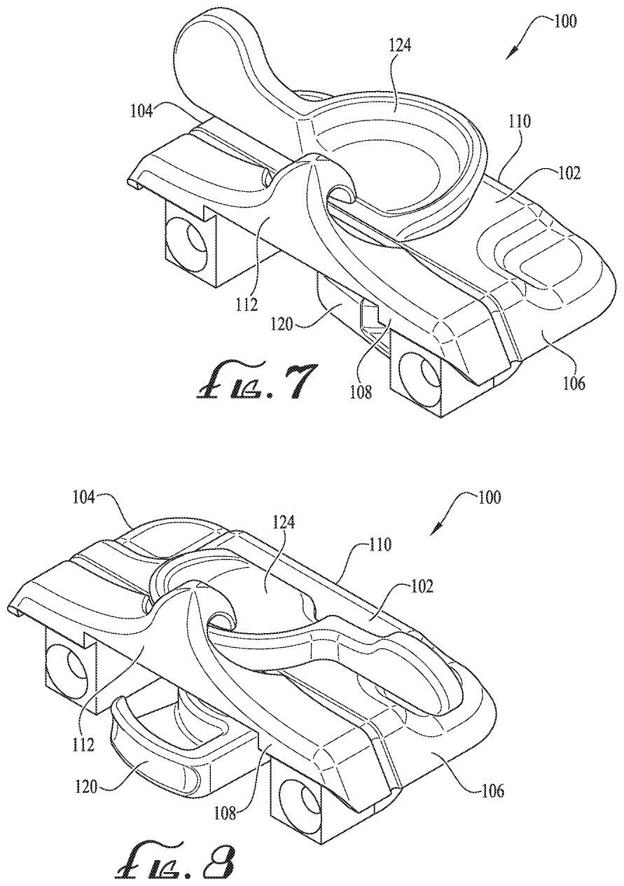

The sash lock assembly 100 includes an actuator 124 and a locking cam 120 operatively coupled to one another, where the actuator 124 and locking cam 120 together serve as the primary locking features of the sash lock assembly 100 as further discussed below with reference to FIGS. 7-10. Turning now to FIG. 4, the actuator 124 includes an arm or handle 126 and a shaft 128 extending downwardly from an underside of the arm 126. In some embodiments, the underside of the arm 126 includes a channel 130 (see FIG. 5) formed thereon and arranged to define a semi-circular pathway, where the channel 130 receives a tab 132 on the top surface 118 of the body 102. The channel 130 and tab 132 cooperate to help retain the actuator 124 on the body 102, with the channel 130 forming a guideway or track for accommodating the motion of operation for the actuator 124 as further discussed below. In an assembled configuration, the shaft 128 extends through the cavity 116 on the body 102 and is coupled with the locking cam 120 disposed underneath the body 102. Additional details of the actuator 124, the locking cam 120, and their interaction are further discussed below.

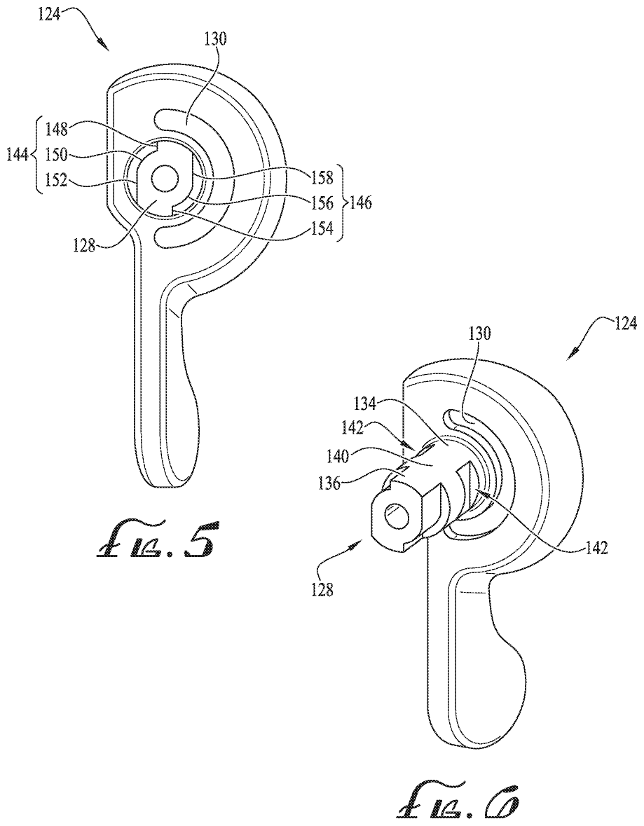

FIGS. 5 and 6 are bottom views of the arm 126 of the actuator 124. With collective reference to FIGS. 5 and 6, the shaft 128 includes an upper region 134 adjacent the underside of the arm 126, and an opposite lower region 136 adjacent the free end of the shaft 128. The shaft 128 is formed with a generally circular cross-section, and further includes features recessed inwardly from its circumferential exterior surface 140. In some embodiments, the shaft 128 includes a pair of notches 142 formed adjacent the upper region 134, and further includes recessed portions adjacent the lower region 136 having a special geometry designed to cooperate with features of the locking cam 120 to allow actuator 124 to rotate within a broader rotation range between the locked and unlocked positions, while restricting the locking cam 120 to a narrower rotation range. For example, in one embodiment, the actuator 124 may accommodate rotation between 0° and 180° when moving from the unlocked position to locked position, while the locking cam 120 moves continuously together with the actuator 124 but along a rotational range of 0° and 90°. Additional details of this configuration are further discussed below with reference to FIGS. 9-10.

As best illustrated in FIG. 5, a portion of the circumferential surface 140 along the lower region 136 of the shaft 128 has recessed or cutaway regions designed to form a pair of corresponding guideways or tracks 144, 146 that interact with the locking cam 120 to achieve the offset rotational movement of the actuator 124 and the locking cam 120 described above. The tracks 144, 146 include multiple different track segments, each track segment having a different surface profile to drive the locking cam 120 as the actuator 124 is rotated. With reference to FIG. 5, the track 144 includes a shoulder 148 that forms a fixed stop point at the end of the track 144. One end portion of the shoulder 148 extends to and adjoins the exterior circumferential surface 140 of the shaft 128. The track 144 further includes a circular or curved track segment 150 transitioning directly from another end portion of the shoulder 148, and a linear track segment 152 transitioning directly from the curved track segment 150. As illustrated in FIG. 5, an end of the linear track segment 152 also adjoins with the exterior circumferential surface 140 of the shaft 128. Similarly, the track 144 includes a shoulder 154, a circular track segment 156, and a linear track segment 158 arranged in an identical configuration as described above with respect to track 146.

Returning to FIG. 4, the following describes additional features and components of the locking cam 120. With reference to FIG. 4, the locking cam 120 includes a body 160 and a post 162 extending upwardly from a top surface of the body 160, the post 162 having a cavity 164 with an opening sized and dimensioned to receive the shaft 128 of the actuator 124. The post 162 includes an interior cavity surface 166 having a pair of ridges 168, 170 (or other suitable engagement members) extending therefrom and generally facing one another within the receiving post 162. Preferably, the ridges 168, 170 are formed as integral components of the locking cam 120. The ridges 168, 170 are generally triangular shaped, with the ridges 168, 170 each having a first segment 172, 178, a second segment 174, 180 and a tip or nose 176, 182 positioned therebetween. In some embodiments, each of the segments 172, 174, 178, 180 are generally planar, with the respective first segments 172, 178 being generally orthogonal to the respective second segments 174, 180. In some embodiments, the first segments 172, 178 may be shorter than the respective second segments 174, 180. In an assembled configuration, the shaft 128 of the actuator 124 is received in the post 162 of the locking cam 120. When the shaft 128 is in proper position within the cavity 164, the ridge 168 contacts the track 144 of the shaft 128, and the ridge 170 contacts the track 146.

FIGS. 7-8 are top perspective views illustrating the sash lock assembly 100 in an unlocked and locked position, and FIGS. 9-10 are bottom views of the sash lock assembly 100 in the unlocked and locked position. With collective reference to FIGS. 7-10, the following discusses the engagement and interaction of the shaft 128 and the locking cam 120 during operation of the sash lock assembly 100.

As noted previously, when the shaft 128 is inserted through the cavity 164 of the receiving post 162, the ridges 168, 170 of the receiving post 162 engage the tracks 144, 146 of the shaft 128, with ridge 168 engaging track 144 and ridge 170 engaging track 146 (or vice versa). As illustrated in FIGS. 7 and 9, when the sash lock assembly 100 is in the unlocked position, the actuator 124 and the locking cam 120 are in their respective zero positions, with each component being essentially aligned relative to an axis A extending through the center of the shaft 128 (see FIG. 9). In this position, the locking cam 120 sits entirely within the base 102 and is retracted inwardly of the top edge 108 of the sash lock assembly 100. In the zero positions, the actuator 124 and the locking cam 120 can be considered as being positioned at 0° relative to axis A when the sash lock assembly 100 is in the unlocked position. With reference to FIG. 9, when the sash lock assembly 100 is in the unlocked position, the second segments 174, 180 of the ridges 168, 170 each rest against and contact the linear segments 152, 158 of the respective tracks 144, 146.

As the actuator 124 is rotated from the unlocked position toward the locked position, the shaft 128 rotates about its axis and continuously drives the locking cam 120 toward the locked position. In other words, the locking cam 120 changes rotational position to coincide with a change in rotational position for the shaft 128. As rotation of the actuator 124 continues, the second segments 174, 180 of the ridges 168, 170 ride against the respective linear segments 152, 158 of the tracks 144, 146. As the actuator 124 and shaft 128 continue to rotate toward the locked position, the contact point of the ridges 168, 170 and the tracks 144, 146 transitions from the second segments 174, 180 to the respective noses 176, 182, where the contact point of the noses 176, 182 also transitions from the linear segments 152, 158 of the tracks 144, 146 to the circular or curved segments 150, 156. At this point, a locking channel 184 (or other suitable lock feature) of the locking cam 120 is exposed beyond the top edge 108 of the body 102 and toward a catch 186 of a keeper 188 mounted on the lower rail 36 of the upper sash 12.

With reference to FIG. 10, when the sash lock assembly 100 is in the fully locked position, the respective noses 176, 182 of the ridges 168, 170 sit at the end of the circular segment 150, 156, and the respective first segments 172, 178 of the ridges 168, 170 sit against and abut the shoulders 148, 154 and the end of respective tracks 144, 146. Due to the geometry of the tracks 144, 146 that the ridges 168, 170 follow during rotation of the shaft 128, the arm 126 (and the shaft 128) is able to move along a rotation range of approximately 180° relative to the axis A as it moves from one peripheral side 104 of the body 102 to the opposite peripheral side 106, while the locking cam 120 only moves along a rotational range of approximately 90° as it moves from one peripheral side 106 of the body 102 to extend outwardly from the top side 108 of the body 102 as illustrated in FIGS. 7-10 collectively.

In other embodiments, the arm 126 (and the shaft 128) may move within a range of between 170° to 190° and the locking cam 120 may move within a range of between 85° and 95° as the sash lock assembly 100 moves between the unlocked and locked positions. It should be understood that in other embodiments, the rotation ranges of the arm 126 and the locking cam 120 may be different than the ranges provided herein. The concept disclosed herein accommodates rotation of the two components, where the arm 126 is designed to move along a range that is approximately twice that of the locking cam 120. Accordingly, in other embodiments, the ranges provided herein may be altered without departing from the principles of the disclosed subject matter.

It will be obvious to those having skill in the art that many changes may be made to the details of the above-described embodiments without departing from the underlying principles of the invention. The scope of the present invention should, therefore, be determined only by the following claims.

1. A lock assembly for fenestration systems, the lock assembly comprising:
a body having a cavity with a first opening formed on a first body surface and a second opening formed on an opposite second body surface;
an actuator including an arm and a shaft coupled to the body, the shaft extending through the cavity of the body, wherein a lower portion of the shaft protrudes from the second opening at the second body surface, the lower portion of the shaft further including a track formed thereon, and wherein the arm is manually actuatable to rotate the shaft within the cavity about a rotational axis; and
a locking cam coupled to the lower portion of the shaft and rotatable therewith, the locking cam including an engagement member seated against the track of the shaft, wherein rotation of the shaft urges rotation of the locking cam, and wherein a degree of the corresponding rotation of the locking cam is based on a position of the engagement member on the track such that the shaft is rotatable through a greater degree of rotational positions relative to the locking cam.

2. The lock assembly of claim 1, wherein the track includes a first track segment having a first track profile and a second track segment having a different second track profile.

3. The lock assembly of claim 2, wherein the first track segment is substantially linear and the second track segment is substantially curved.

4. The lock assembly of claim 1, wherein the track further includes a stop against which the engagement member abuts to limit rotation of the shaft and the locking cam.

5. The lock assembly of claim 1, wherein the lower portion of the shaft further includes a second track offset from the first track, and wherein the locking cam further includes a second engagement member seated against the second track.

6. The lock assembly of claim 1, wherein the track is formed as a recessed portion of an exterior circumferential surface of the shaft

7. The lock assembly of claim 1, wherein the arm is manually actuatable to rotate the shaft through approximately 180 degrees of rotation, and wherein the locking cam correspondingly rotates through approximately 90 degrees of rotation.

8. The lock assembly of claim 1, wherein the actuator further includes a channel formed on the second body surface, and the body further includes a ridge disposed within the channel to accommodate movement of the arm of the actuator.

9. The lock assembly of claim 1, wherein the body further includes a keeper and a catch formed as an integral component of the body along the first body surface thereof.

10. A window assembly comprising:
a window frame;
an upper sash and a lower sash mounted within the window frame, wherein at least one of the upper or lower sash windows is slidable relative to the other within the window frame, and wherein one of the upper or lower sash windows includes a first keeper with a first catch mounted on a rail thereof and the other of the upper or lower sash windows includes a lock assembly mounted on a rail thereof, the lock assembly further comprising:
a body having a cavity with a first opening formed at a first body surface and a second opening formed at an opposite second body surface, the body further including a second keeper with a second catch;
an actuator including an arm and a shaft coupled to the body, the shaft extending through the cavity of the body, wherein a lower portion of the shaft protrudes from the second opening at the second body surface, and wherein the arm is manually actuatable to rotate the shaft within the cavity about a rotational axis; and
a locking cam coupled to the lower portion of the shaft for continuous rotation therewith, wherein rotation of the shaft urges rotation of the locking cam, and wherein the locking cam mates with the first catch of the first keeper mounted on the rail of the upper or lower sash when the lock assembly is in the locked position, and wherein the locking cam is positioned underneath the second body surface of the body when the lock assembly is in the unlocked position.

11. The window assembly of claim 10, wherein the lower portion of the shaft further includes a track formed thereon, and wherein the locking cam includes an engagement member seated against the track of the shaft, and wherein a degree of the corresponding rotation of the locking cam in response to rotation of the shaft is based on a position of the engagement member on the track, and wherein the shaft is rotatable through a greater degree of rotational positions relative to the locking cam.

12. The window assembly of claim 11, wherein the track includes a first track segment having a first track profile and a second track segment having a different second track profile.

13. The window assembly of claim 12, wherein the first track segment is substantially linear and the second track segment is substantially curved.

14. The window assembly of claim 11, wherein the track further includes a stop against which the engagement member abuts to limit rotation of the shaft and the locking cam.

15. The window assembly of claim 11, wherein the lower portion of the shaft further includes a second track offset from the first track, and wherein the locking cam further includes a second engagement member seated against the second track.

16. The window assembly of claim 11, wherein the track is formed as a recessed portion of an exterior circumferential surface of the shaft

17. The window assembly of claim 10, wherein the arm is manually actuatable to rotate the shaft through approximately 180 degrees of rotation, and wherein the locking cam correspondingly rotates through approximately 90 degrees of rotation.

18. The window assembly of claim 10, wherein the actuator further includes a channel formed on the second body surface, and the body further includes a ridge disposed within the channel to accommodate movement of the arm of the actuator.

19. The window assembly of claim 10, wherein the second keeper and second catch are formed as integral components of the body of the lock assembly.

20. A lock assembly comprising:
a body having a cavity with a first opening formed at a first body surface and a second opening formed at an opposite second body surface, the body further including a keeper and a catch formed as integral components of the body;
an actuator including an arm and a shaft coupled to the body, the shaft extending through the cavity of the body, wherein a lower portion of the shaft protrudes from the second opening at the second body surface, and wherein the arm is manually actuatable to rotate the shaft within the cavity about a rotational axis; and
a locking cam coupled to the lower portion of the shaft for continuous rotation therewith, wherein rotation of the shaft urges rotation of the locking cam, and wherein a degree of the corresponding rotation of the locking cam is based on a position of the engagement member on the track such that the shaft is rotatable through a greater degree of rotational positions relative to the locking cam.
